(19) United States
(12) Patent Application Publication
(10) Pub. No.: US 2019/0265698 A1
(43) Pub. Date: Aug. 29, 2019

(54) SYSTEMS AND METHODS FOR TELE-PRESENT RECOVERY OF SELF-DRIVING VEHICLES

(71) Applicant: Clearpath Robotics Inc., Kitchener (CA)

(72) Inventors: Anthony William TOD, St. Agatha (CA); David Andrew BROWN, Kitchener (CA); Ryan Christopher GARIEPY, Kitchener (CA); Matthew Allen RENDALL, Waterloo (CA)

(21) Appl. No.: 16/288,162

(22) Filed: Feb. 28, 2019

Related U.S. Application Data
(60) Provisional application No. 62/636,817, filed on Feb. 28, 2018.

(51) Int. Cl. G05D 1/00; G05D 1/02

(52) U.S. Cl. CPC G05D 1/0061; G05D 1/0038; G05D 2201/0213; G05D 1/0246; G05D 1/0088

(57) ABSTRACT

Systems and methods for tele-present recovery of self-driving vehicles are disclosed. The system comprises one or more self-driving vehicles, a server, and a master-assistance device. The vehicle operates in a full-autonomous mode until a problem is encountered, triggering a vehicle status associated with a master-assisted intervention. A master-assisted intervention request and associated environment state information are sent from the server to the master-assistance device. A human operator of the master-assisted intervention device provides input indicative of operational commands for the vehicle. The operational commands are received by the vehicle, and the vehicle is operated in a semi-autonomous mode based on the operational commands. When the problem has been resolved, an assistance complete message is sent to the vehicle, and the vehicle returns to operating in the full-autonomous mode.

### CROSS-REFERENCE TO RELATED PATENT APPLICATION

The application claims the benefit of U.S. Provisional Patent Application No. 62/636,817, filed on Feb. 28, 2018. The complete disclosure of U.S. Provisional Patent Application No. 62/636,817 is incorporated herein by reference.

### FIELD

The described embodiments relate to self-driving vehicles, and in particular, to systems and methods for tele-present recovery of self-driving vehicles.

### BACKGROUND

The following paragraphs are not an admission that anything discussed in them is prior art or part of the knowledge of persons skilled in the art.

Self-driving vehicles have been proposed as technological solutions to a variety of transportation applications. For example, self-driving cars may be used for public and private transport. Self-driving material-transport vehicles may be used within industrial facilities such as factories and warehouses in order to efficiently move inventory and work pieces as part of a larger automated industrial facility solution.

However, in addition to providing new solutions, self-driving vehicle technology currently experiences a variety of new problems as well. For example, self-driving vehicles can experience various system failures while operating in remote locations. Self-driving vehicles can become stuck or blocked by objects that they cannot navigate around. Self-driving vehicles can experience errors and failures in perception, localization, and control.

### SUMMARY

In a first aspect, there is a method for tele-present recovery of a self-driving vehicle. The method comprises determining that the vehicle has a vehicle status indicative of a master-assisted intervention, collecting environment state information, generating a request for a master-assisted intervention based on the vehicle status, and transmitting the master-assisted intervention request to a master-assistance device. Operational commands are received from the master-assistance device, and the vehicle is controlled according to the operational commands.

According to some embodiments, the vehicle is operated in a full-autonomous mode prior to determining that the vehicle has the vehicle status indicative of the master-assisted intervention. Subsequent to determining that the vehicle has the status indicative of the master-assisted intervention, the vehicle is operated in a semi-autonomous mode. Operating the vehicle in the full-autonomous mode consists of exclusive control of the vehicle, by the vehicle itself, according to a path planned by the vehicle. Operating the vehicle in the semi-autonomous mode comprises controlling the vehicle according to the operational commands.

According to some embodiments, an assistance-complete message is received subsequent to controlling the vehicle according to the operational commands. The vehicle is then operated in the full-autonomous mode subsequent to receiving the assistance-complete message.

According to some embodiments, a second location of the vehicle is determined based on controlling the vehicle according to the operational commands, and second environment state information associated with the second location is collected. The second environment state information is transmitted to the master-assistance device. Subsequently, second operational commands are received from the master-assistance device based on the second environment state information, and the vehicle is controlled according to the second operational commands.

According to some embodiments, collecting the environment state information comprises sensing an environment of the vehicle using an environmental sensor.

According to some embodiments, the environmental sensor comprises at least one camera, and the environment state information comprises at least one image of the environment.

According to some embodiments, the camera is mounted in the facility in which the vehicle is operation (e.g. within the vehicle's environment) but not on the vehicle itself.

According to some embodiments, the camera is mounted on the vehicle.

According to some embodiments, collecting the environment state information comprises retrieving map data based on a location of the vehicle.

### BRIEF DESCRIPTION OF THE DRAWINGS

Several embodiments will now be described in detail with reference to the drawings, in which:

FIG. 1 is a system diagram of a system for the tele-present recovery of a self-driving vehicle according to at least one embodiments;

FIG. 2 is a block diagram of a self-driving vehicle in the system shown in FIG. 1, according to at least one embodiment;

FIG. 3 is a block diagram of a self-driving vehicle in the system shown in FIG. 1, according to at least one embodiment;

FIG. 4 is a block diagram of a method for the tele-present recovery of a self-driving vehicle according to at least one embodiment; and

FIG. 5 is a block diagram of a method for the tele-present recovery of a self-driving vehicle according to at least one embodiments.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

It is often believed that further improvements to self-driving vehicles must rely on improvements to the autonomous technology underlying the self-driving vehicles, for example, by improving autonomous decision-making capabilities, algorithms, and computer power. However, contrary to this belief is the possibility that self-driving vehicles can be improved by including a semi-autonomous mode of operation in addition to a full-autonomous mode.

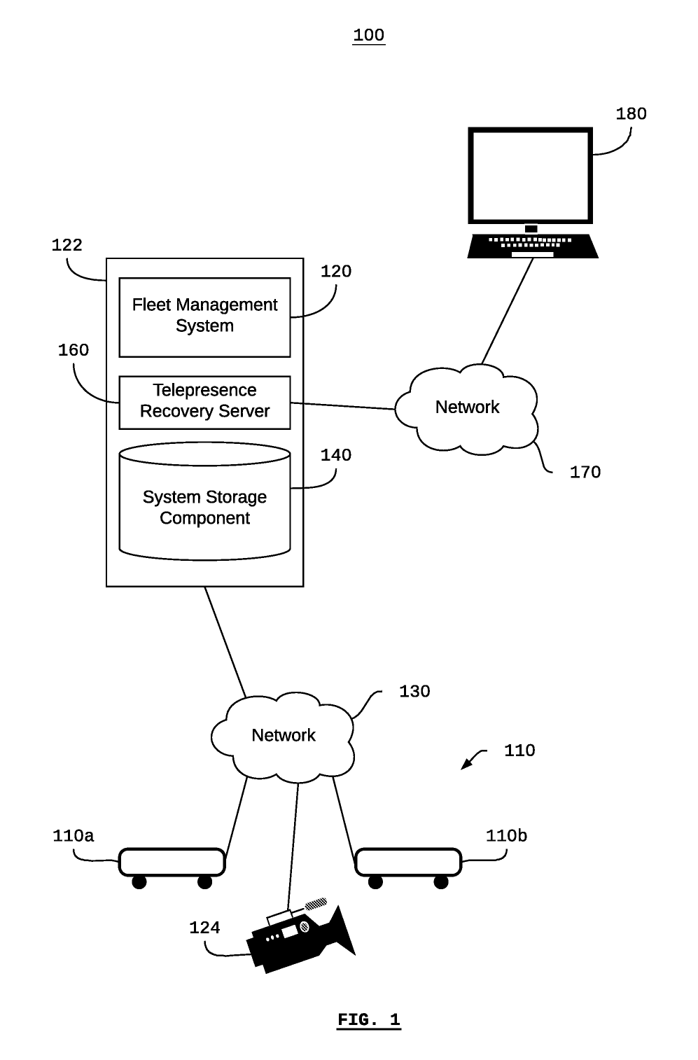

Referring to FIG. 1, there is shown a system 100 of one or more self-driving industrial vehicles 110, according to at least one embodiment. The system 100 can include one or more self-driving industrial vehicles 110, a fleet-management system 120, a first network 130, a system storage component 140, a telepresence recovery server 160, and master-assistance device 180 in communication via a second network 170. While FIG. 1 shows the system 100 having two self-driving industrial vehicles 110a and 110b for illustrative purposes. The system 100 can include one or more self-driving industrial vehicles 110. Similarly, the system 100 can include one or more master-assistance devices 180.

According to some embodiments, a fleet-management system 120 may be used to provide a mission to a self-driving industrial vehicle 110. The fleet-management system 120 has a processor, memory, and a communication interface (not shown) for communicating with the network 130. The fleet-management system 120 uses the memory to store computer programs that are executable by the processor (e.g. using the memory) so that the fleet-management system 120 can communicate information with other systems, and communicate with one or more self-driving industrial vehicles 110. In some embodiments, the fleet-management system 120 can also generate missions for the self-driving industrial vehicles 110.

Any or all of the self-driving industrial vehicles 110 and the fleet-management system 120 may communicate with the network 130 using known telecommunications protocols and methods. For example, each self-driving industrial vehicle 110 and the fleet-management system 120 may be equipped with a wireless communication interface to enable wireless communications within a LAN according to a WiFi protocol (e.g. IEEE 802.11 protocol or similar), or via a WWAN according to a 3G/4G protocol. The master-assistance device 180 may similarly communicate with any or all of the fleet-management system 120, the system storage component 140, and the telepresence recovery server 160 via the network 170.

According to some embodiments, the system storage component 140 can store information about the self-driving industrial vehicles 110 as well as electronic maps of the facilities within which the self-driving industrial vehicles 110 operate (i.e. the vehicle's environment).

According to some embodiments, and as indicated by the box 122 in FIG. 1, the fleet-management system 120, the system storage component 140, and the server 160 may be implemented in the same computing device that is in communication with the network 130. Similarly, according to some embodiments, any one or two of the fleet-management system 120, the system storage component 140, and the server 160 may be implemented using a unique computing device in communication with the network 130. For simplicity and illustration, the fleet-management system 120, the system storage component 140, and the server 160 are shown as individual components within the system 122

Generally, the server can be used to make master-assisted intervention requests to a master-assistance device 180. The telepresence recovery server 160 has a processor, memory, and may have a communication interface (not shown) for communicating with the network 130 and/Or the network 170. The telepresence recovery server 160 uses the memory to store computer programs that are executable by the processor (e.g. using the memory) so that the telepresence recovery server 160 can communicate information with other systems, such as the fleet-management system 120 and/or the vehicles 110 and/or the master-assistance device 180. According to some embodiments, the processor, memory, and communication interface may be shared with (or shared from) the fleet-management system; in other words, implemented on the same computing device as the fleet-management system.

The system 100 may include one or more master-assistance devices 180. Generally, the master-assistance devices 180 have a processor, memory, and communications interface (not shown) and are in communication with the network 170. Master-assistance devices may be desktop computer terminals, laptop computers, mobile devices such as mobile phone, smart phone, tablets, and smart watches, display-walls and display-wall controllers, virtual and augmented reality displays, and other similar devices. Further, the master-assistance devices may include or receive input from input devices such as keyboards, joysticks, gesture-recognition systems, voice-recognition systems, etc. The communications interfaces may be used for wired and/or wireless communications, for example, with the network 170.

The system 100 may also include one or more environmental sensors, such as a camera 124, that is located within the facility, but not attached to the vehicles 110. The one or more environmental sensors may communicate with the system 100 via the network 130.

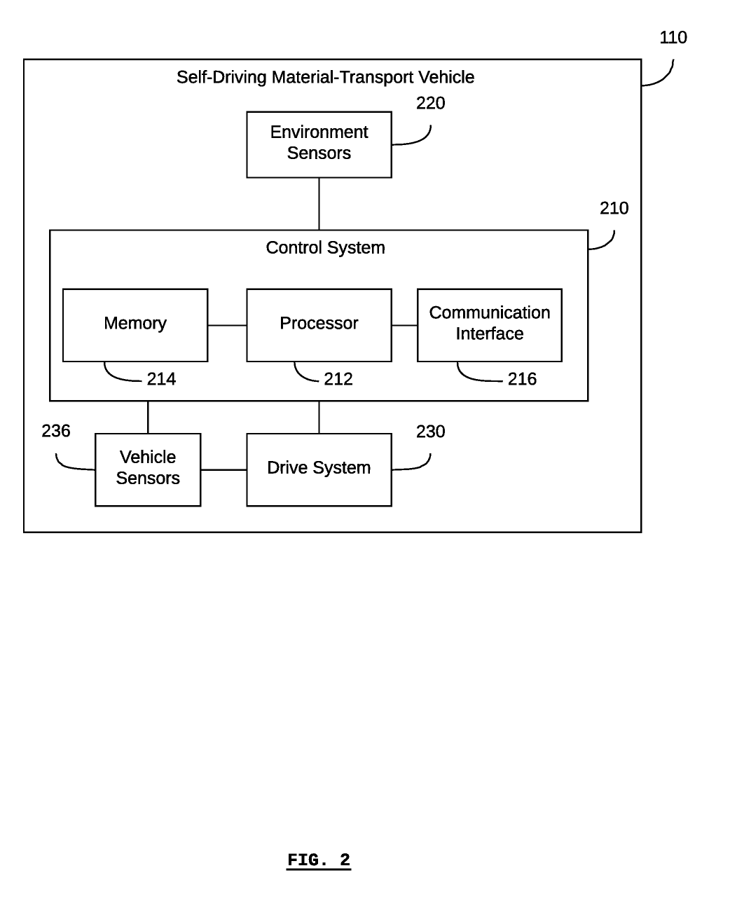

Referring to FIG. 2, there is shown a block diagram of a self-driving industrial vehicle 110, according to at least one embodiment. The self-driving industrial vehicle 110 generally includes a control system 210, at least one environment sensor 220, a drive system 230, and at least one vehicle sensor 236.

The control system 210 can include a processor 212, memory 214, and a communication interface 216. The control system 210 enables the self-driving industrial vehicle 110 to operate automatically and/or autonomously. The control system 210 can store an electronic map that represents the environment of the self-driving industrial vehicle 110, such as a facility, in the memory 214.

According to some embodiments, the communication interface 216 can be a wireless transceiver for communicating with a wireless communications network (e.g. using an IEEE 802.11 protocol, a 3G/4G protocol or similar).

One or more environment sensors 220 may be included in the self-driving industrial vehicle 110 to obtain data about the environment of the self-driving industrial vehicle 110. These environment sensors 220 can be distinguished from other sensors 236. For example, according to some embodiments, an environment sensor 220 may be a LiDAR device (or other optical, sonar, or radar-based range-finding devices known in the art). An environment sensor 220 may comprise optical sensors, such as video cameras and systems (e.g., stereo vision, structured light). Other examples of environment sensors include humidity sensors for measuring the ambient humidity in the facility, thermal sensors for measuring the ambient temperature in the facility, and microphones for detecting sounds.

According to some embodiments, the self-driving industrial vehicle 110 may receive a mission from a fleet-management system 120 or other external computer system in communication with the self-driving industrial vehicle 110 (e.g. in communication via the communication interface 216). In this case, the mission contains one or more waypoints or destination locations. Based on the waypoint or destination location contained in the mission, the self-driving industrial vehicle 110, based on the control system 210, can autonomously navigate to the waypoint or destination location without receiving any other instructions from an external system. For example, the control system 210, along with the sensors 220, enable the self-driving industrial vehicle 110 to navigate without any additional navigational aids such as navigational targets, magnetic strips, or paint/tape traces installed in the environment in order to guide the self-driving industrial vehicle 110.

For example, the control system 210 may plan a path for the self-driving industrial vehicle 110 based on a destination location and the location of the self-driving industrial vehicle 110. Based on the planned path, the control system 210 may control the drive system 230 to direct the self-driving industrial vehicle 110 along the planned path. As the self-driving industrial vehicle 110 is driven along the planned path, the environmental sensors 220 may update the control system 210 with new images of the environment of the self-driving industrial vehicle 100, thereby tracking the progress of the self-driving industrial vehicle 110 along the planned path and updating the location of the self-driving industrial vehicle 110.

Since the control system 210 receives updated images of the environment of the self-driving industrial vehicle 110, and since the control system 210 is able to autonomously plan the self-driving industrial vehicle's path and control the drive system 230, the control system 210 is able to determine when there is an obstacle in the self-driving industrial vehicle's path, plan a new path around the obstacle, and then drive the self-driving industrial vehicle 110 around the obstacle according to the new path.

The self-driving industrial vehicle 110 may also comprise one or more vehicle sensors 236. These vehicle sensors generally measure and monitor the state of the vehicle 110 itself, as compared to the environment sensors 220, which sense the vehicle's environment. The vehicle sensors 236 may be associated with particular components of the vehicle 110. For example, the vehicle sensors 236 may be current and/or voltage sensors for measuring the current and/or voltage of a particular electrical component, or for determining an approximate state of battery charge. The vehicle sensors 236 may be encoders for measuring the displacement, velocity, and/or acceleration (e.g. angular displacement, angular velocity, angular acceleration) of mechanical components such as motors, wheels, and shafts. The vehicle sensors 236 may be thermal sensors for measuring heat, for example, the heat of a motor or brake. The vehicle sensors 236 may be inertial measurement units for measuring motion of the body of the vehicle 110 (e.g. the vehicle sensors 236 may comprising accelerometers, gyroscopes, etc.). The vehicle sensors 236 may be water ingress sensors for detecting water within the body of the vehicle 110.

According to some embodiments, vehicle state information may not be limited to only the information derived from the vehicle sensors 236. For example, vehicle state information may also pertain to the mission that the vehicle is executing, the status of the mission, and other operational parameters known to the control system 210 independent of input from the vehicle sensors 236.

For simplicity and clarity of illustration, the example shown in FIG. 2 shows a single block labelled “environment sensors” 220 and a single block labelled “vehicle sensors” 236, each in communication with the control system 210. According to some embodiments, there may be any number of environment sensors 220 and/or vehicle sensors 232, which may or may not all be in communication with the drive system 230, depending on the nature of the particular environment sensors and vehicle sensors 236. In this example, the vehicle sensors 236 are shown in communication with the drive system 230 in order to measure characteristics of the drive system 230, for example, motor speed, motor temperature, etc.

The vehicle environment sensors 220 are generally in communication with the control system 210 so that the control system 210 can received the measurements from the environment sensors, for example, in order to determine or provide environment state information. Similarly, the vehicle sensors 236 are generally in communication with the control system 210 so that the control system 210 can received the measurements from the vehicle sensors, for example, in order to determine or provide vehicle state information.

According to some embodiments, the environment sensors 220 on the vehicle may further include environment sensors that are not used for autonomously navigating and moving the vehicle (e.g. autonomous obstacle avoidance). For example, and as further described below, additional cameras may be mounted on the vehicle in order to collect environment state information that can be used to generate or render a virtual environment, visualizations, and/or intervention instructions, without the additional cameras providing information for the vehicle while operating in full-autonomy mode.

The positions of the components 210, 212, 214, 216, 220, 230, and 236 of the self-driving industrial vehicle 110 are shown for illustrative purposes and are not limited to the positions shown. Other configurations of the components 210, 212, 214, 216, 220, 230, and 236 are possible.

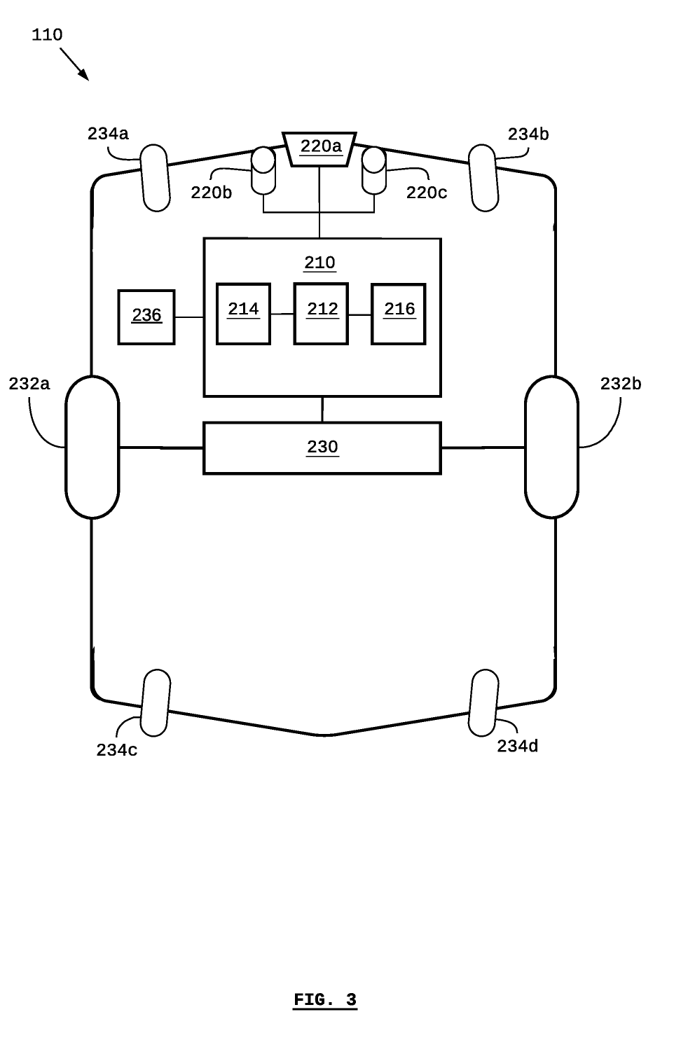

Referring to FIG. 3, there is shown a block diagram of a self-driving industrial vehicle 110, according to at least one embodiment. The drive system 230 includes a motor and/or brakes connected to drive wheels 232a and 232b for driving the self-driving industrial vehicle 110. According to some embodiments, the motor may be an electric motor, a combustion engine, or a combination/hybrid thereof. According to some embodiments, there may be one motor per drive wheel, for example, one for drive wheel 232a and one for drive wheel 232b. Depending on the particular embodiment, the drive system 230 may also include control interfaces that can be used for controlling the drive system 230. For example, the drive system 230 may be controlled to drive the drive wheel 232a at a different speed than the drive wheel 232b in order to turn the self-driving industrial vehicle 110. Different embodiments may use different numbers of drive wheels, such as two, three, four, etc.

According to some embodiments, additional wheels 234 may be included (as shown in FIG. 3, the wheels 234a, 234b, 234c, and 234d may be collectively referred to as the wheels 234). Any or all of the additional wheels 234 may be wheels that are capable of allowing the self-driving industrial vehicle 110 to turn, such as castors, omnidirectional wheels, and mecanum wheels.

According to some embodiments, the environment sensors 220 (as shown in FIG. 3, the sensors 220a, 220b, and 220c may be collectively referred to as the environment sensors 220) may be optical sensors arranged in a manner to provide three-dimensional (e.g. binocular or RGB-D) imaging.

The vehicle 110 may also include one or more vehicle sensors 236, as previously described in respect of FIG. 2.

The positions of the components 210, 212, 214, 216, 220, 230, 232, 234, and 236 of the self-driving industrial vehicle 110 are shown for illustrative purposes and are not limited to the shown positions. Other configurations of the components 210, 212, 214, 216, 220, 230, 232, 234, and 236 are possible.

Generally, one or more vehicles 110 may comprise a fleet of vehicles that operates within an industrial facility. As a vehicle is operating (or is unable to operate) within the facility, the vehicle may experience one or more states or conditions. These states and conditions can be reflected in one or both of vehicle state information and environment state information.

As used herein, “vehicle state information” refers to information indicative of the state of a vehicle, for example, as determined by the vehicle sensors 236. Non-limiting examples of vehicle state include “active”, “inactive”, “working”, “idle”, “emergency stop”, “safety stop”, and “vehicle malfunction/error”. Vehicle state information can also include detailed information such as whether a vehicle is on a mission or queued for a mission, and what the nature of the mission is. Furthermore, Vehicle state information can include detailed information such as a particular type of error or malfunction that the vehicle is experiencing, and the particular components and subsystems that are failing or experiencing an error or malfunction. Further descriptions of vehicle state information are provided in Patent Application No. 62/620,184 entitled “Systems and Methods for Measuring Fleets of Self-driving Industrial Vehicles” and filed on 22 Jan. 2018, and in Patent Application No. 62/621,519 entitled “Systems and Methods for Monitoring Fleets of Self-Driving Industrial Vehicles”, both of which are hereby incorporated by reference in their entirety.

As used herein, “environment state information” refers to information indicative of the state of the environment experienced by the vehicle, for example, as determined by the environment sensors 220. Environment state information can includes the presence or absence of objects with respect to a particular location, such as objects detected by environment sensors such as LiDARs and vision systems. Environment state information also includes the electronic map (or parts thereof) stored on the vehicle and/or the system storage component.

As used herein, “performance metric” refers to information indicative of the state of the fleet of vehicles, for example, as determined by aggregate vehicle state information collected by multiple vehicles within the fleet. According to some embodiments, the fleet of vehicles may generally be used in the execution of an industrial or manufacturing process being conducted within the facility. Generally, a stage or step in the process may be associated with a vehicle mission. As such, vehicle state information, such as information pertaining to a mission, the execution of a mission, the time taken to execute a mission, etc., may be used to calculate performance metrics of the fleet. Examples of fleet-performance metrics include, but are not limited to: takt times, mean-time before interruption (for vehicle failure within the fleet), system availability (e.g. percentage of time for which the fleet is unable to supply the necessary vehicles to the process due to system or vehicle error), the number of production cycles run in a unit of time, mission durations, etc.

The vehicle 110 described in FIG. 2 and FIG. 3 is provided as an example and in reference to some embodiments. However, the systems and methods contemplated herein may also be embodied with other types of vehicles. Such vehicles are not limited to being self-driving vehicles, nor to being terrestrial vehicles. For example, vehicles used in indoor and/or outdoor industrial facilities and environments may be used. Vehicles on public roadways may be used. Aerial vehicles, such as autonomous aerial vehicles may be used. Aquatic vehicles such as autonomous or automated boats may be used.

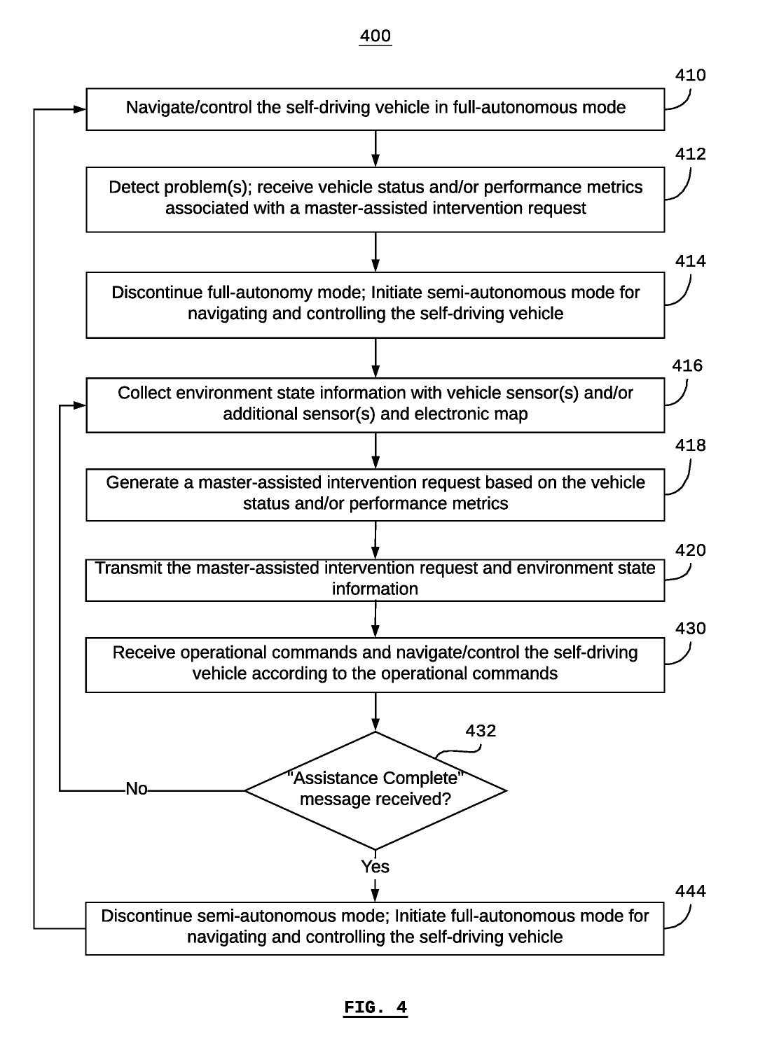

Referring to FIG. 4, there is a method 400 for the tele-present recovery of a self-driving vehicle. According to some embodiments, all or parts of the method 400 may be executed by a server such as the telepresence recovery server 160 or by a fleet-management system such as the fleet-management system 120. According to some embodiments, all or parts of the method 400 may be executed using a system storage component such as the system storage component 140, and one or more vehicles such as the fleet of vehicles 110.

According to some embodiments, a single computer system may be used to implement any or all of the fleet-management system, the telepresence recovery server, and the system storage component. In such a case, the single system, for example the system 122 in FIG. 1 may be referred to as the “telepresence recovery server” or the “server”.

The method 400 may begin at step 410, when the self-driving vehicle is operating in full-autonomous mode. According to some embodiments, “full-autonomous mode” means that the vehicle is navigating and/or controlling itself by planning a path to a final destination based on an electronic map of the vehicle's environment. For example, the vehicle may plan a path based on the vehicle's current location and a final destination location, by calculating a route based on the constraints of the map such as objects and navigational rules defined relative to the map. After planning the path, the vehicle may move along the path by controlling its motors and/or brakes and/or steering system as the case may be. While moving along the path, the vehicle may take further steps to avoid obstacles that are detected by the vehicle's sensors, for example, obstacles that were not known in the map at the time that the vehicle was planning the path. According to some embodiments, “full-autonomous mode” differs from “semi-autonomous mode” in that the former does not involve any human operator input or intervention in order to move from its current location to a final destination location.

Generally, as the vehicle is operating in full-autonomous mode, it is collecting environment state information and vehicle state information. For example, the vehicle is collecting environment state information when it is using its environment sensors to detect objects in its environment, such as for obstacle avoidance and/or creating or updating the electronic map. The vehicle is collecting vehicle state information based on its vehicle sensors, which can determine when the vehicle is experiencing a system error or failure, when the vehicle is not moving as expected, etc. Generally, performance metrics can be determined based on the vehicle state information and/or environment state information. According to some embodiments, the vehicle may update the fleet-management system or other server with its vehicle status or changes in its vehicle status. The fleet-management system or other server may determine performance metrics based on the vehicle statuses.

The fleet-management system, server, or system storage component may store a table, list, or database associating vehicle statuses and/or performance metrics with a master-assisted intervention request. In other words, these associations may be used to determine when it is necessary to make a master-assisted intervention request, for example, based on a vehicle status or performance metric.

At step 412, a problem may be detected. For example, a vehicle status and/or performance metric associated with a master-assisted intervention may be received. According to some embodiments, a vehicle status and/or performance metric associated with a master-assisted intervention generally means that the vehicle is stopped, for example, because it is blocked by an unexpected object that it can't navigate around (e.g. a narrow aisle from which the vehicle is prevented from navigating in full-autonomy mode), it is required to navigate relative to a reference point that it does not fully recognize, or it is experiencing a navigational or perception error; and therefore stops moving.

According to some embodiments, the problem may be detected by the vehicle itself; that is, the vehicle status may be known to the vehicle as being a vehicle status associated with a master-assisted intervention request.

According to some embodiments, the problem may be detected by the fleet-management system and/or server; that is, the fleet-management system and/or server may detect that a vehicle is not moving towards its destination as expected, or that the vehicle has been stopped for a particular period of time.

According to some embodiments, a problem may be associated with a particular step in a process or a particular mission type. For example, if a particular process or mission requires that the vehicle navigate based on an object or landmark that the vehicle cannot recognize (or otherwise use as a navigational aid), then the execution of the process or mission may be deemed a “problem” according to step 412.

At step 414, full-autonomy mode is discontinued, and semi-autonomous mode is initiated. According to some embodiments, step 414 may be executed at any time and in any order after step 412 and before the step 430. According to some embodiments, when semi-autonomous mode is initiated, the vehicle is not moving and is waiting for operational commands for subsequent movement.

According to some embodiments, semi-autonomous mode may be initiated by the vehicle based on a vehicle status that is known to the vehicle as being associated with a master-assisted intervention request.

According to some embodiments, semi-autonomous mode may be initiated by the vehicle based on an instruction or command received by the fleet-management system and/or server.

At step 416, environment state information is collected. According to some embodiments, environment state information may include any or all of the information received from the vehicle's environment sensors, information received from the vehicle and/or system storage component based on the electronic map, and information received from environment sensors placed within the environment but not attached to the vehicle (e.g. security/monitoring cameras placed within a facility in which the vehicle is operating). Generally, the environment state information is collected in order to provide the master-assistance device with information that will assist a human operator in solving the problem that was detected at step 412.

According to some embodiments, the environment state information may be collected by the vehicle, for example, using environment sensors.

According to some embodiments, the environment state information may be collected by the fleet-management system and/or server from the vehicle (e.g. as collected by the vehicle's sensors and/or the electronic map stored on the vehicle), from an environment sensor not attached to the vehicle (e.g. a camera mounted within the facility), and/or from the system storage component (e.g. the electronic map).

At step 418, a master-assisted intervention request is generated based on the vehicle status and/or performance metrics associated with the problem detected at step 412. For example, based on vehicle status and/or performance metrics, the master-assisted intervention request may include information such as “vehicle blocked”, “perception error”, “navigation error”, “vehicle/process operating too slowly”, etc.

According to some embodiments, the master-assisted intervention request may be generated by the vehicle.

According to some embodiments, the master-assisted intervention request may be generated by the fleet-management system and/or server.

At step 420, the master-assisted intervention request and the environment state information are transmitted to the master-assistance device. According to some embodiments, the environment state information may be compressed, encoded, or otherwise processed, prior to being sent to the master-assistance device.

According to some embodiments, the master-assisted intervention request and/or the environmental state information may be transmitted by the vehicle to the fleet-management system and/or server, or to a master-assistance device. According to some embodiments, the master-assisted intervention request and/or the environmental state information may be transmitted by the fleet-manager and/or server to the master-assistance device.

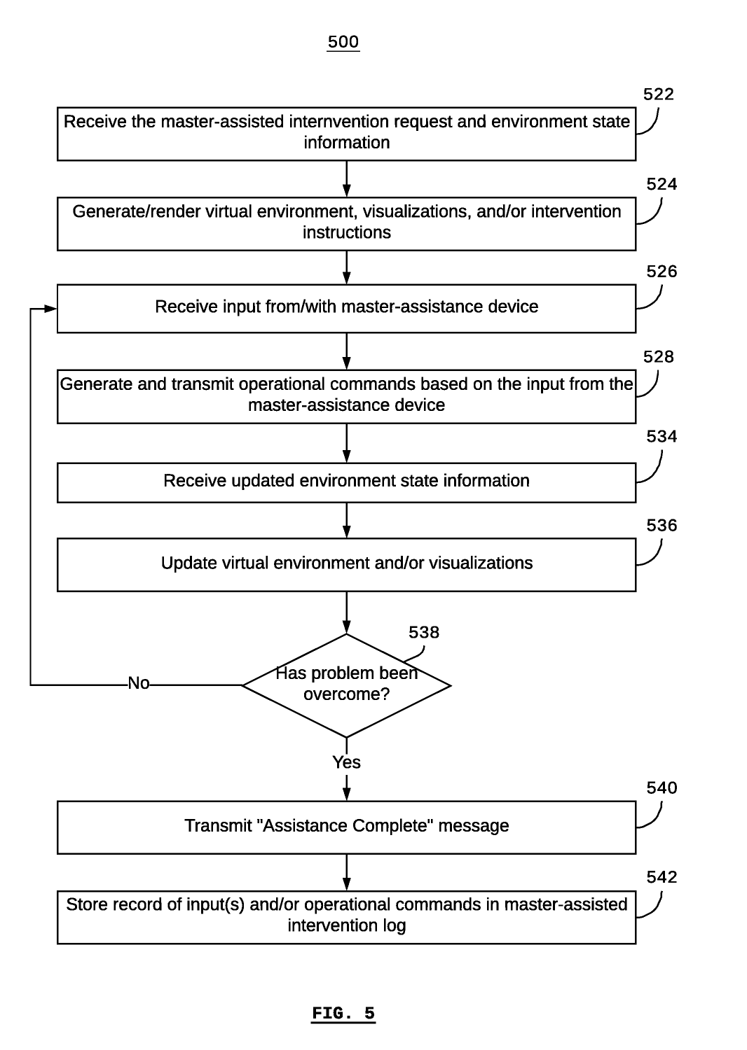

Referring to FIG. 5, there is a method 500 for monitoring a fleet of self-driving vehicles. According to some embodiments, all or parts of the method 500 may be executed by a fleet-management system, server (e.g. a telepresence recovery server), and/or one or more master-assistance devices. According to some embodiments, the method 500, or its constituent steps, may be executed along with or as a part of the method 400 or its constituent steps. For the sake of convenience, and according to some embodiments, the steps of the method 500 have been numbered in order to accord with the general sequence of steps of the method 400.

Generally, the method 400 in FIG. 4 and the method 500 in FIG. 5 may be executed using any or all of a vehicle (e.g. the vehicle's control system), a fleet-management system, a server (e.g. a telepresence recovery server), a system storage component, and one or more master-assistance devices. For example, in some cases, the method 400 may be executed primarily by the vehicle and/or the server, and the method 500 may be executed primarily by the server and/or a master-assistance device.

The method 500 may begin at step 522, when the master-assisted intervention request and environment state information are received. According to some embodiments, the information received in step 522 may correspond to the information transmitted during the step 420 of the method 400. According to some embodiments, the information may be received by the server (e.g. from the fleet-management system or vehicle as the case may be) and/or by the master-assistance device.

At step 524, a virtual environment and/or visualizations and/or intervention instructions are generated. The virtual environment, visualizations, and/or intervention instructions may be generated using any or all of the environmental state information received during the step 522.

For example, based on any or all of the electronic map (including or based on the location of the vehicle relative to the map), and environmental state information from sensors (e.g. images, video, LiDAR scans, etc.), a virtual environment can be rendered and displayed on a master-assistance device for use by a human operator.

According to some embodiments, the virtual environment, visualizations, and/or intervention instructions may be generated by the fleet-management system and/or server, and transmitted to a master-assistance device in order to be displayed on the master-assistance device.

According to some embodiments, the virtual environment, visualizations, and/or intervention instructions may be generated and/or rendered by the master-assistance device.

Generally, the virtual environment, visualizations, and/or intervention instructions are used in order to represent the problem (e.g. the problem detected during the step 412) to a human operator of the master-assistance device.

At step 526, input is received from the master-assistance device. Generally, this input is based on input provided by a human operator. According to some embodiments, the master-assistance device may include (or may be in communication with) input devices such as keyboard, mouse, joysticks, gesture-recognition cameras, etc. For example, the virtual environment, visualizations, and/or intervention instructions of step 524 may include a three-dimensional or two-dimensional (e.g. plan view) rendering of the vehicle's environment (including obstacles and other objects relevant to the vehicle's operation) and a representation of the vehicle itself. As such, a human user may use the input device to “drive” the representation of the vehicle within the virtual environment.

According to some embodiments, the input may be received by the master-assistance device from a keyboard, mouse, joystick, gesture-recognition system, voice-recognition system, and the like.

According to some embodiments, the input may be received by the fleet-management system and/or server from the master-assistance device.

At step 528, operational commands may be generated and/or transmitted based on the input from step 526. For example, the master-assistance device or fleet-management system/server, as the case may be, may translate the input into operational commands that are relevant for instructing the vehicle.

According to some embodiments, the operational commands may be in the form of control instructions for the vehicle's control system. For example, operational commands may be in the form of instructing the vehicle to move with a particular velocity (i.e. speed and direction), or instructing particular controls within the vehicle (e.g. motor speed). In such a case, the input from the step 526 may be used to determine the desired vehicle velocity, or motor speed, as the case may be.

According to some embodiments, the operational commands may be in the form of discrete temporary-destination locations that the vehicle is instructed to move to. As such, the vehicle may plan its own path and move from one temporary-destination location to the next. Ultimately, the operational commands are used with the semi-autonomous mode of operation. As such, when operational commands are in the form of discrete temporary-destination locations, semi-autonomous mode can be distinguished from full-autonomous mode based on the fact that the temporary-destination locations provided in the operational commands are independent of the final destination location (e.g. that may have been used in the original path planning by the previous full-autonomous mode), are generally closer together (i.e. much shorter paths from one temporary-destination location to the next, as compared to the original path to the final destination). In other words, the temporary-destination locations associated with operational commands are used as a solution to a problem encountered while on route to a final destination location; and since the temporary-destination locations are provided based on human-operator input, they are compatible with a semi-autonomous mode and not a full-autonomous mode.

According to some embodiments, the operational commands may be generated by the master-assistance device and transmitted to the fleet-management system and/or server, which subsequently relays the operational commands to the vehicle. According to some embodiments, the operational commands may be generated by the master-assistance device and transmitted directly to the vehicle. According to some embodiments, the operational commands may be generated by the fleet-management system and/or server based on the input from the master-assistance device, and then transmitted from the fleet-management system and/or server to the vehicle.

Referring again to FIG. 4, at step 430, the operational commands are received. According to some embodiments, the operational commands may be received by the fleet-management system and/or server (and then relayed to the vehicle). According to some embodiments, the operational commands may be received by the vehicle.

Once the operational commands have been received by the vehicle, the vehicle, now operating in semi-autonomous mode, is navigated and/or controlled according to the operational commands.

According to some embodiments, the operational commands may be in the form of control instructions for vehicle's control system. In such a case, the vehicle operates in semi-autonomous mode according to the control instructions interpreted by the vehicle's control system. According to some embodiments, the operational commands may be in the form of temporary-destination locations. In such a case, the vehicle operates in semi-autonomous mode by planning a path and moving from one temporary-destination location to the next.

The execution of any particular operational command my serve to solve the problem that was originally detected. At step 432, if the problem has not been solved—in other words, if an “assistance complete” message has not been received, then the method may return to any of steps 416 to 430.

The method may return to step 416. For each iteration of the method through step 416, the vehicle may have moved to a new location based on previously-executed operational commands. As such, new environmental state information may be collected. Subsequently, the method continues through to step 420, where the new/updated environment state information is transmitted.

Referring again to FIG. 5, the method may proceed from step 420 to step 534. For each iteration through step 522, new/updated environment state information may be received.

At step 536, the virtual environment, visualizations, and/or intervention instructions may be updated (e.g. rendered) based on the new/updated environment state information.

At step 538, a determination is made as to whether the problem (e.g. the problem detected in step 412) has been overcome. According to some embodiments, this determination may be made by the human operator of the master-assistance device. According to some embodiments, this determination may be made by the fleet-management system and/or server, for example, based on updated vehicle status and/or performance metrics.

If, at step 538, it is determined that the problem has not been overcome, then the method returns to step 526 and new input is received, as previously described with respect to step 526. If, at step 538, it is determined that the problem has been overcome, then an “assistance complete” message is transmitted.

According to some embodiments, the human operator of the master-assistance device may provide input associated with an “assistance complete” message. According to some embodiments, fleet-management system/server or master-assistance device may automatically transmit the “assistance complete” message.

At step 542, a record of the input(s) and/or operational commands may be stored in a master-assisted interventions log. According to some embodiments, the master-assisted interventions log may be stored on the system storage component, fleet-management system, or server, as the case may be.

Referring again to FIG. 4, if the “assistance complete” message has been received, then the method proceeds to step 444. At step 444, semi-autonomous mode is discontinued, and full-autonomous mode is initiated. The vehicle subsequently operates in full-autonomous mode (for example as in step 410), until another problem is detected (for example, as in step 412).

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

As used herein, the term “media” generally means “one medium or more than one medium”.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the programmable computers may be a server, network appliance, embedded device, computer expansion module, a personal computer, laptop, a wireless device or any other computing device capable of being configured to carry out the methods described herein.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims.

We claim:

1. A method for tele-present recovery of a self-driving vehicle, comprising:
determining that the vehicle has a vehicle status indicative of a master-assisted intervention;
collecting environment state information;
generating a request for a master-assisted intervention based on the vehicle status;
transmitting the master-assisted intervention request to a master-assistance device;
receiving operational commands from the master-assistance device; and
controlling the vehicle according to the operational commands.

2. The method of claim 1, further comprising:
prior to determining that the vehicle has the vehicle status indicative of the master-assisted intervention, operating the vehicle in a full-autonomous mode; and
subsequent to determining that the vehicle has the vehicle status indicative of the master-assisted intervention, operating the vehicle in a semi-autonomous mode;
wherein operating the vehicle in the full-autonomous mode consists of controlling the vehicle according to a path planned by the vehicle, and operating the vehicle in the semi-autonomous mode comprises the controlling the vehicle according to the operational commands.

3. The method of claim 2, further comprising:
subsequent to the controlling the vehicle according to the operational commands:
receiving an assistance-complete message; and
operating the vehicle operating the vehicle in the full-autonomous mode subsequent to receiving the assistance-complete message.

4. The method of claim 1, further comprising:
subsequent to the controlling the vehicle according to the operational commands:
determining a second location of the vehicle based on the controlling the vehicle according to the operational commands;
collecting second environment state information associated with the second location;
transmitting the second environment state information to the master-assistance device;
receiving second operational commands from the master-assistance device based on the second environment state information; and
controlling the vehicle according to the second operational commands.

5. The method of claim 1, wherein collecting the environment state information comprises sensing an environment of the vehicle using an environmental sensor.

6. The method of claim 5, wherein the environmental sensor comprises at least one camera and the environment state information comprises at least one image of the environment.

7. The method of claim 6, wherein the camera is not mounted on the vehicle.

8. The method of claim 6, wherein the camera is mounted on the vehicle.

9. The method of claim 1, wherein collecting the environment state information comprises retrieving map data based on a location of the vehicle.

10. The method of claim 9, wherein collecting the environment state information further comprises sensing an environment of the vehicle using an environmental sensor.

11. A system for tele-present recovery of a self-driving vehicle, comprising:
a server configured to:
receive a vehicle status associated with a master-assisted intervention request;
collect environment state information;
generate a master-assisted intervention request based on the vehicle status; and
transmit the master-assisted intervention request and environment state information to a master-assistance device; and
the master-assistance device configured to:
receive the master-assisted intervention request and environment state information from the server;
receive input from a human operator of the master-assistance device; and
transmit the input to the server;
the server further configured to:
transmit operational commands to the vehicle based on the input.

12. The system of claim 11, wherein the master-assistance device is further configured to generate a graphical rendering based on the environment state information, the graphical rendering representing an environment of the vehicle, and display the graphical rendering on a graphical display.

13. The system of claim 12, wherein:
the server is further configured to:
subsequent to transmitting the operational commands to the vehicle, collect second environment state information; and
transmit the second environment state information to the master-assistance device; and
the master-assistance device is further configured to:
update the graphical rendering based on the second environment state information and display the updated graphical rendering on the graphical display.

14. The system of claim 11, wherein the server configured to collect environment state information comprises receiving environment state information from the vehicle, the environment state information having been sensed by an environmental sensor on the vehicle.

15. The system of claim 14, wherein the server configured to collect environment state information further comprises retrieving an electronic map, such that the environment state information comprises the electronic map.

16. A system for tele-present recovery of a self-driving vehicle, comprising:
a server configured to:
receive a vehicle status associated with a master-assisted intervention request from the vehicle;
collect environment state information;
generate a master-assisted intervention request based on the vehicle status; and
transmit the master-assisted intervention request and environment state information to a master-assistance device;
the master-assistance device configured to:
receive the master-assisted intervention request and environment state information from the server;
receive input from a human operator of the master-assistance device; and
transmit the input to the server;
the server further configured to:
transmit operational commands to the vehicle based on the input; and
the vehicle configured to:
operate in a full-autonomous prior to transmitting the vehicle status associated with a master-assisted intervention request to the server;
receive the operational commands from the server; and
operate in a semi-autonomous mode based on the operational commands.

17. The system of claim 16, wherein:
the server is configured to:
subsequent to transmitting the operational commands to the vehicle, collect second environment state information; and
transmit the second environment state information to the master-assistance device;
the master-assistance device is further configured to:
receive an assistance complete message from a human user; and
transmit the assistance complete message to the server;
the server is further configured to transmit the assistance complete message to the vehicle; and
the vehicle is further configured to operate the vehicle in the full-autonomous mode based on the assistance complete message.
